(19) United States
(12) Patent Application Publication
(10) Pub. No.: US 2008/0259222 A1
(43) Pub. Date: Oct. 23, 2008

(54) Providing Information Related to Video Content

(75) Inventors: Robert Hardacker, Escondido, CA (US); Brant Candelore, San Diego, CA (US); Chris Read, San Diego, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignees: SONY CORPORATION, Tokyo (JP); SONY ELECTRONICS, INC., Parkridge, NJ (US)

(21) Appl. No.: 11/737,363

(22) Filed: Apr. 19, 2007

(51) Int. Cl. H04N 5/74

(52) U.S. Cl. 348/744

(57) ABSTRACT

An apparatus for providing information related to video content includes a video display that displays the video content to a user. A content identifier identifies a segment of interest in the video content. An information processor obtains additional information related to the segment of interest. A presentation unit presents the additional information to the user. The additional information may be provided on a second device different than the video display, such as on a remote control for the video display. A link to the additional information may be presented to the user and presentation of the additional information may be in response to the selection of the link. The additional information may include ordering and an order may be received from the user and transmitted to vendor by the apparatus.

### BACKGROUND

Video programs, which may include audio content, may be received by a variety of device for display. It may be desirable to display additional information related to segments of the received video program. Examples of video program delivery would be the delivery of content by an off-air receiver, a cable set top box, a digital versatile disk (DVD) player, or a digital video recorder. These devices may provide the video content via an analog or digital signal connection that provides for the delivery of content to a display device such as a television monitor or projector.

It would be useful to provide an apparatus and a method that allows a display device to provide an enhanced display that includes additional information related to segments of the received video program.

### SUMMARY

An apparatus for providing information related to video content includes a video display that displays the video content to a user. A content identifier identifies a segment of interest in the video content. An information processor obtains additional information related to the segment of interest. A presentation unit presents the additional information to the user. The additional information may be provided on a second device different than the video display, such as on a remote control for the video display. A link to the additional information may be presented to the user and presentation of the additional information may be in response to the selection of the link. The additional information may include ordering and an order may be received from the user and transmitted to vendor by the apparatus.

Other features of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIG. 1 is a block diagram of an apparatus that embodies the invention.

FIG. 2A is a block diagram of a portion of the apparatus of FIG. 1 showing another operative state.

FIG. 2B is a block diagram of another portion of the apparatus of FIG. 1 showing another operative state.

FIG. 3A is a block diagram of another apparatus that embodies the invention.

FIG. 3B is a detail portion of the apparatus of FIG. 3A.

FIG. 4A is a block diagram of a portion of the apparatus of FIG. 3A showing another operative state.

FIG. 4B is a detail portion of the apparatus of FIG. 3C.

FIG. 4C is a block diagram of a portion of the apparatus of FIG. 3A showing another operative state with an alternate video presentation.

FIG. 5A is a block diagram of another apparatus that embodies the invention.

FIG. 5C is a block diagram of the apparatus of FIG. 5A showing another operative state.

FIG. 6 is a block diagram of a portion of another apparatus that embodies the invention.

FIG. 7 is a flowchart for a method that embodies the invention.

FIG. 8 is a flowchart for another method that embodies the invention.

FIG. 9 is a flowchart for another method that embodies the invention.

### DETAILED DESCRIPTION

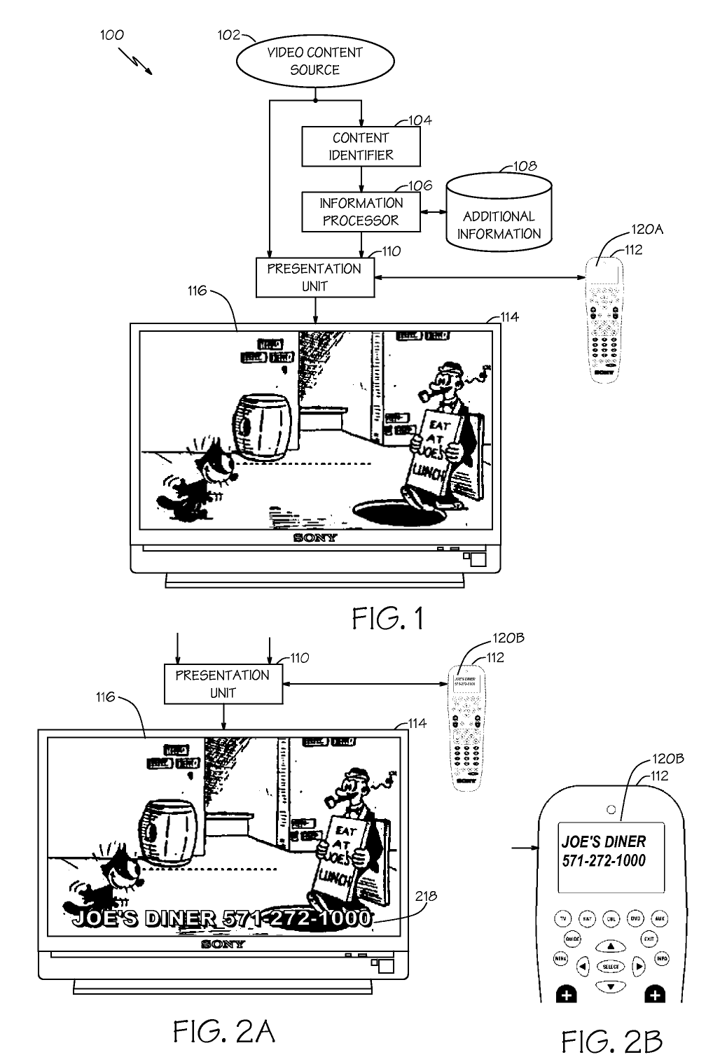

FIG. 1 is a block diagram of an apparatus 100 for providing information related to video content. A source of video content 102 provides video content 116 that is displayed on a video display such as a television monitor 114. Video content as used herein refers to multimedia content that includes audio-visual elements. The video content 116 may be transferred from the source 102 to the display 114 by a presentation unit 110 which is described in greater detail below.

The video content 116 is also provided to a content identifier 104 that identifies the video content and estimates a playback position within the video content. An information processor 106 determines if there is additional information related to the playback position within the video contents. If there is additional information, the information processor 106 obtains the additional information from a database 108. The database may be a remote database and the information processor 106 may communicate with the database by a network connection.

The presentation unit 110 receives the additional information obtained by the information processor 106 as well as the video content 116 received from the source 102. The presentation unit 110 may also be communicatively coupled to a user interface device such as a remote control 112 for the display 114. The communicative coupling may be a wireless link such as an infrared (IR) optical link or a radio frequency (RF) link. The user interface device 112 may include a user display 120A such as a liquid crystal display (LCD). The communicative coupling may be a bi-directional link that allows information to be sent to the user interface device 112 that may be presented on the user display 120A. The presentation unit 110 presents the additional information to the user.

FIG. 1 provides an example of how a device that embodies the invention might operate. The video content source 102 provides video content 116 that is displayed on a video monitor 114. The content identifier 104 identifies the content 116 that is being viewed and the approximate playback location within the content. In the example shown in FIG. 1, the sign reading “Eat at Joe's Lunch” might be linked to additional information about Joe's Diner. The information processor 106 would then obtain additional information about Joe's Diner.

The presentation unit 110 presents the additional information to the user. As shown in FIG. 2A, the additional information may be presented as a video overlay 218 to the video content 116. As shown in FIG. 2B, the additional information may be presented to the user on a second device 112 different than the video display 114. In this example the second device is a remote control 112 for the video display 114. The remote control 112 may include a display 120B, such as an LCD display, and receive the additional information to be displayed from the presentation unit 110. The presentation unit 110 might use either of both of these exemplary methods of presenting the additional information to the user or other methods of presenting the additional information such as an audio only or a full screen audio-video presentation. The additional information may include information about how and/or where the additional information is to be presented. For example, the additional information may be provided in a markup language, such as hypertext markup language (HTML) or extended markup language (XML), that includes both content and presentation information.

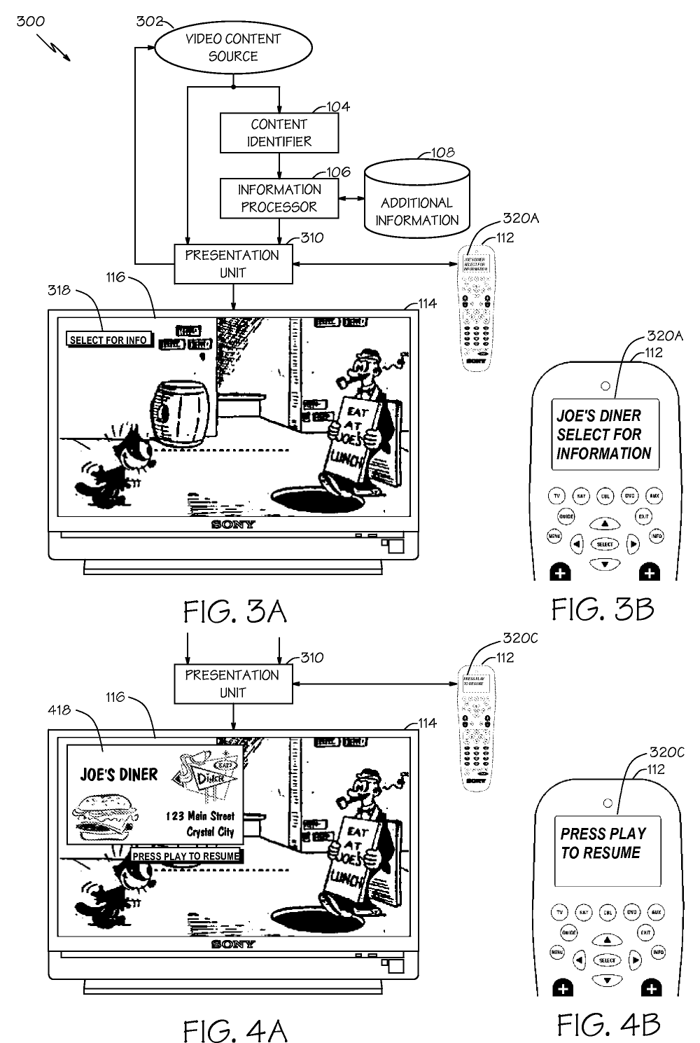

FIG. 3A is a block diagram of another apparatus 300 for providing information related to video content. In this embodiment, the information processor 106 obtains a link to the additional information. The presentation unit 310 presents the link 318 to the user. In the example shown, there is only one link 318 and the user is asked to press Select to receive the additional information. The link may be presented as a video overlay 318 on the video content, as a display 320A (FIG. 3B) on a second device 112, or both.

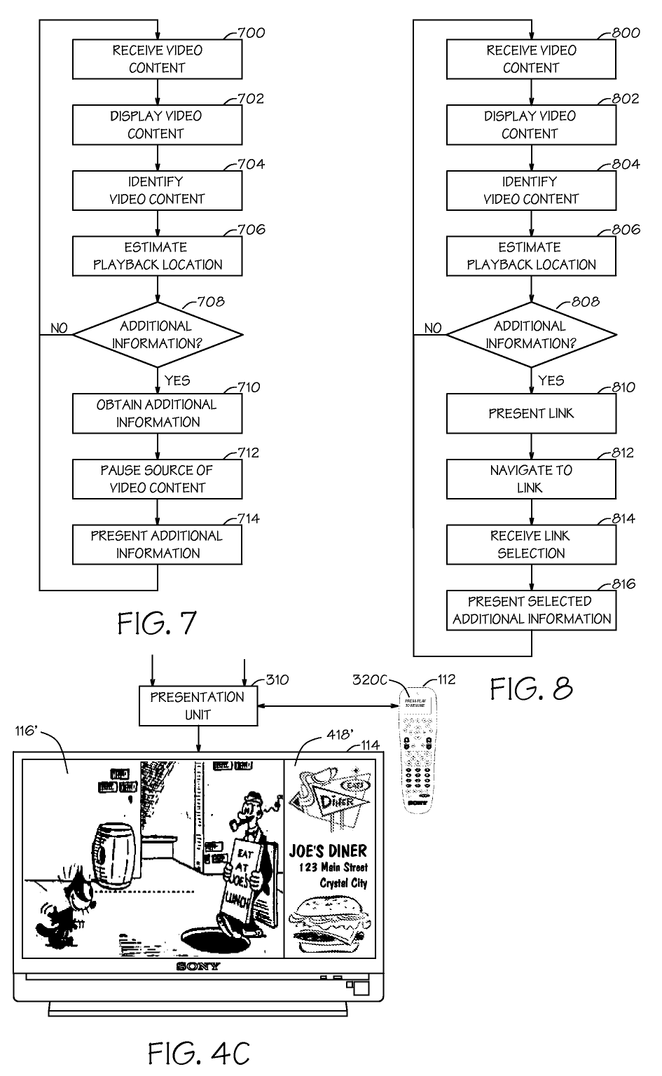

As shown in FIG. 4A, the additional information 418 is presented by the presentation unit 310 when it receives a selection of the link 318 from the user. The additional information 418 may be presented as a picture-in-picture (PIP) display 418, as shown. In another embodiment, the received video content may be presented as the PIP display with the additional information as the full screen display. As an alternative shown in FIG. 4C, the additional information 418′ may be presented as a picture out of picture (POP) display in which the received video content 116′ may be squeezed to provide a display area for the additional information. In other embodiments, the additional information may be presented as a video overlay, as a display on another device, as another form of presentation such as audio or a full screen video, or by any combination of presentation methods.

Again referring to FIG. 3A, the video content may be received from a video content source 302 that can be paused. In this embodiment the presentation unit 310 may cause the source 302 to pause playback of the video content 116 while the additional information 418 (FIG. 4A) is presented to the user. The presentation unit 310 may provide an indication to the user of an action needed to resume playback, such as a message 320C (FIG. 4B) on the remote control 112.

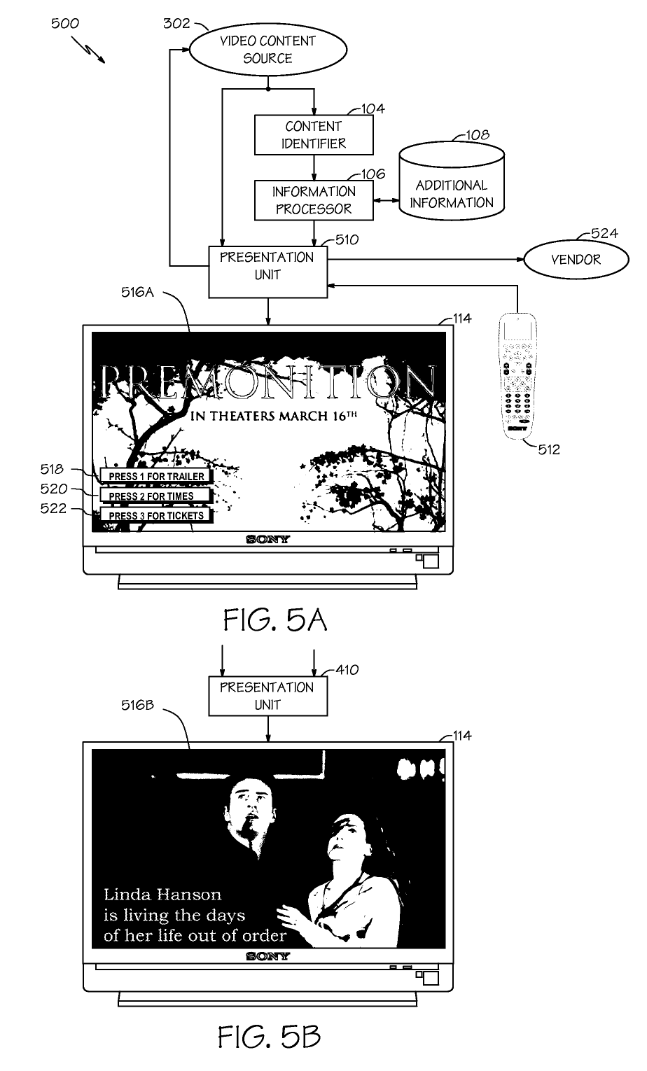

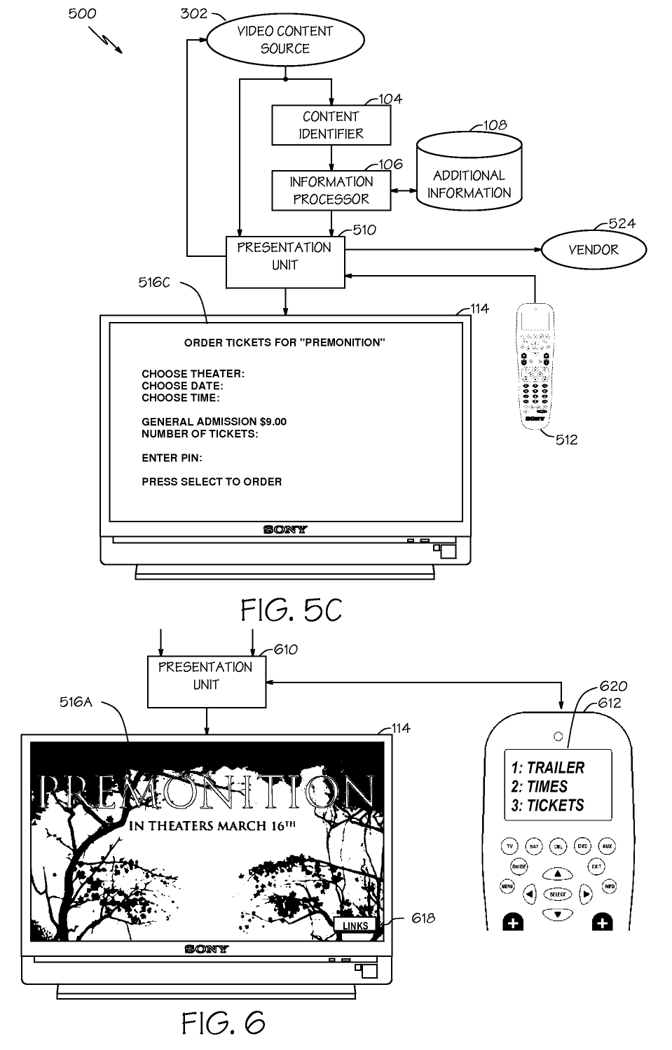

FIG. 5A is a block diagram of another apparatus 500 for providing information related to video content. In the example shown, the information processor has obtained three links to additional information. In this example, the presentation unit 510 presents the links 518, 520, 522 to the user as a video overlay on the video content 516A. In this embodiment, the remote control 512 is shown as a device that can provide input to the presentation unit 510. Therefore, the links on the screen inform the user of what action is necessary to make a selection, in this case by using the number keys on the remote 512.

FIG. 5B shows an example of the result of selecting the link to the trailer 518 for the movie being advertised 516A as part of the video content received from the video source 302. In this case, the additional information is a full screen video 516B that completely replaces the display of the video content 516A. When the additional information is a full screen video 516B, it may be particularly advantageous for the presentation unit 510 to pause the playback of the video source 302.

FIG. 5C shows an example of the result of selecting the link to buy tickets 522 for the movie being advertised 516A. In this case, the additional information may be a full screen order entry display 516C that completely replaces the display of the video content 516A. The user may use the remote control 512 to fill in the order entry under the control of the presentation unit 510. When the user presses a key, such as Select, to place the order, the presentation unit 510 may transmit the order to a vendor 524 using a link to the vendor included with the additional information. The link may be a network address, such as a Universal Resource Locator (URL), on a network, such as the Internet.

FIG. 6 is a portion of a block diagram of another apparatus for providing information related to video content. In this embodiment, the remote control 612 can display information 620 provided by the presentation unit 610. In the example shown, which is similar to the example shown in FIG. 5A, the presentation unit 510 presents the links to the user on the display 620 of the remote control and indicates that links are available as a video overlay 618 on the video content 516A. In other respects, this embodiment provides functions similar to those of preceeding embodiments.

FIG. 7 is a flowchart for a method of providing information related to video content that embodies the invention. Video content is received 700 and displayed to a user 702. The video content is identified 704. A playback position within the video content is estimated 706. A database is consulted to determine if there is additional information related to the playback position within the video contents 708. If there is no additional information related to the current playback position 708-NO, the method continues to receive video content and check for additional information at successive playback positions.

If there is additional information 708-YES, the additional information is obtained 710 and presented to the user 714. Playback by the source of the video content may be paused while the additional information is presented to the user 712. The video content may be displayed to the user on a first device and the additional information may be presented to the user on a second device, such as a remote control for the first device. The additional information may be presented to the user as a picture-in-picture display or a video overlay over the video content or it may replace the display of the video content. The additional information may be presented to the user as an audio presentation. The additional information may be presented by more than type of display. After the additional information has been presented to the user 714, additional video content may be received 700.

FIG. 8 is a flowchart for another method of providing information related to video content that embodies the invention. Video content is received 800 and displayed to a user 802. The video content is identified 804. A playback position within the video content is estimated 806. A database is consulted to determine if there is additional information related to the playback position within the video contents 808. If there is no additional information related to the current playback position 808-NO, the method continues to receive video content and check for additional information at successive playback positions.

If there is additional information 808-YES, the additional information may be in the form of one or more links. The one or more links may be presented to the user 810. Navigation to the link responsive to inputs received from the user may be provided 812. A selection of a link may be received from the user 814. Presentation of the additional information to the user may be responsive to the selection of the link 816. The video content may be displayed to the user on a first device and the link may be presented to the user on a second device such as a remote control for the first device. After the additional information has been presented to the user 816, additional video content may be received 800.

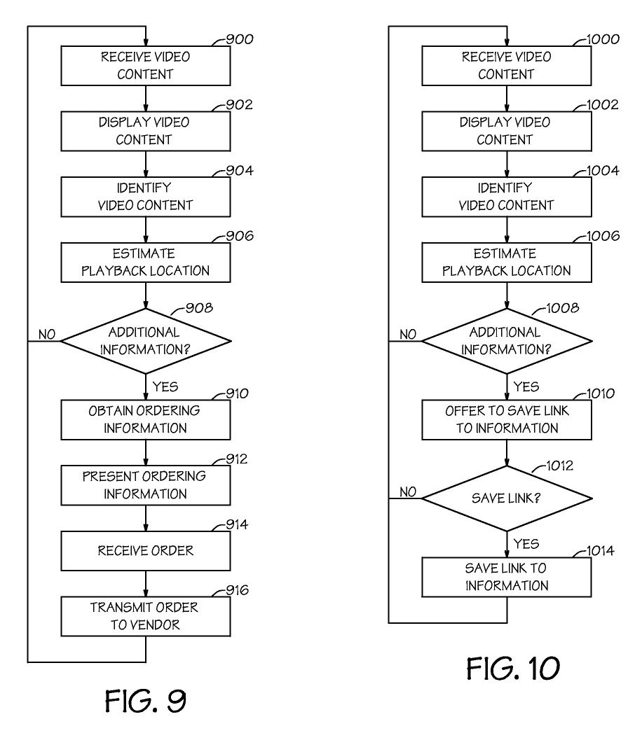

FIG. 9 is a flowchart for a method of providing information related to video content that embodies the invention. Video content is received 900 and displayed to a user 902. The video content is identified 904. A playback position within the video content is estimated 906. A database is consulted to determine if there is additional information related to the playback position within the video contents 908. If there is no additional information related to the current playback position 908-NO, the method continues to receive video content and check for additional information at successive playback positions.

If there is additional information 908-YES, the additional information may be in the form of ordering information to purchase goods or services, make reservations for dining, make travel arrangements, and the like. The ordering information is obtained 910 and presented to the user 912. An order may be received from the user 914. The order may be transmitted to a vendor using a link to the vendor provided with the additional information 916. Additional personal information for processing the order may be transmitted to the vendor. After transmitting the order 916, additional video content may be received 900.

FIG. 10 is a flowchart for another method of providing information related to video content that embodies the invention. Video content is received 1000 and displayed to a user 1002. The video content is identified 1004. A playback position within the video content is estimated 1006. A database is consulted to determine if there is additional information related to the playback position within the video contents 1008. If there is no additional information related to the current playback position 1008-NO, the method continues to receive video content and check for additional information at successive playback positions.

If there is additional information 1008-YES, an offer to save a link to the information is presented to the user 1010. If the user selects the option to save the link 1012-YES, the link to the additional information is saved for later use by the user 1014. Playback by the source of the video content may continue while the offer to save the link is presented to the user 1010. The video content may be displayed to the user on a first device and the offer to save the link may be presented to the user on a second device, such as a remote control for the first device. Offering to save a link may be done as an alternative to pausing the display of the video content or when the video content cannot be paused. Saved links may be kept until deleted or they may be deleted automatically after being viewed or after some time has elapsed since they were saved.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. An apparatus for providing information related to video content, the apparatus comprising:
a video display that displays the video content to a user;
a content identifier that identifies the video content and estimates a playback position within the video content;
an information processor that determines if there is additional information related to the playback position within the video contents and, if so, obtains the additional information; and
a presentation unit that presents the additional information to the user.

2. The apparatus of claim 1 wherein the additional information is presented to the user on a second device different than the video display.

3. The apparatus of claim 1 wherein the additional information is presented to the user on a remote control for the video display.

4. The apparatus of claim 1 wherein the additional information is presented to the user on the video display as one of a picture-in-picture (PIP) display, a picture outside picture (POP) display, and a video overlay.

5. The apparatus of claim 1 wherein:
the information processor further obtains a link to the additional information; and
the presentation unit further
presents a link for the additional information to the user,
provides navigation to the link responsive to inputs received from the user,
receives a selection of the link from the user, and
presents the additional information to the user in response to the selection of the link.

6. The apparatus of claim 5 wherein the link is presented to the user on a second device different than the video display.

7. The apparatus of claim 5 wherein the link is presented to the user on a remote control for the video display.

8. The apparatus of claim 5 wherein the link is stored for presentation to the user at a later time.

9. The apparatus of claim 1 wherein the video content is received from a source that can be paused and the presentation unit further causes the source to pause while the additional information is presented to the user.

10. The apparatus of claim 1, wherein the additional information includes ordering information and a link to a vendor, the presentation unit further:
presents the ordering information to the user;
receives an order from the user; and
transmits the order to the vendor using the link.

11. A method of providing information related to video content, the method comprising:
displaying the video content to a user;
identifying the video content;
estimating a playback position within the video content;
determining if there is additional information related to the playback position within the video contents; and
if there is additional information, obtaining the additional information and presenting the additional information to the user.

12. The method of claim 11 wherein the video content is displayed to the user on a first device and the additional information is presented to the user on a second device different than the first device.

13. The method of claim 11 wherein the video content is displayed to the user on a first device and the additional information is presented to the user on a remote control for the first device.

14. The method of claim 11 wherein the additional information is presented to the user as one of a picture-in-picture (PIP) display, a picture outside picture (POP) display, and a video overlay over the video content.

15. The method of claim 11 further comprising:
presenting a link for the additional information to the user;
providing navigation to the link responsive to inputs received from the user;
receiving a selection of the link from the user; and
wherein presenting the additional information to the user is responsive to the selection of the link.

16. The method of claim 15 wherein the video content is displayed to the user on a first device and the link is presented to the user on a second device different than the first device.

17. The method of claim 15 wherein the video content is displayed to the user on a first device and the link is presented to the user on a remote control for the first device.

18. The method of claim 15 further comprising storing the link for presentation to the user at a later time.

19. The method of claim 11 wherein the video content is received from a source that can be paused and method further comprises pausing the source while the additional information is presented to the user.

20. The method of claim 11, wherein the additional information includes ordering information and a link to a vendor, the method further comprising:
presenting the ordering information to the user;
receiving an order from the user; and
transmitting the order to the vendor using the link.

21. An apparatus for providing information related to video content, the apparatus comprising:
means for displaying the video content to a user;
means for identifying a segment of interest in the video content;
means for determining if there is additional information related to the playback position within the video contents; and
means for obtaining additional information related to the segment of interest; and
means for presenting the additional information to the user.

22. The apparatus of claim 21 wherein the additional information is presented to the user on a second device different than the means for displaying the video content.

23. The apparatus of claim 21 wherein the additional information is presented to the user on a remote control for the means for displaying the video content.

24. The apparatus of claim 21 wherein the additional information is presented to the user on the means for displaying the video content as one of a picture-in-picture (PIP) display, a picture outside picture (POP) display, and a video overlay.

25. The apparatus of claim 21 further comprising:
means for presenting a link for the additional information to the user;
means for providing navigation to the link responsive to inputs received from the user; and
means for receiving a selection of the link from the user;
wherein means for presenting the additional information to the user is responsive to the selection of the link.

26. The apparatus of claim 25 wherein the link is presented to the user on a second device different than the means for displaying the video content.

27. The apparatus of claim 25 wherein the link is presented to the user on a remote control for the means for displaying the video content.

28. The apparatus of claim 25 further comprising means for storing the link for presentation to the user at a later time.

29. The apparatus of claim 21 wherein the video content is received from a source that can be paused and apparatus further comprises means for pausing the source while the additional information is presented to the user.

30. The apparatus of claim 21 wherein the additional information includes ordering information and a link to a vendor, the apparatus further comprising:
means for presenting the ordering information to the user;
means for receiving an order from the user; and
means for transmitting the order to the vendor using the link.
